(19) United States
(12) Patent Application Publication
(10) Pub. No.: US 2017/0115249 A1
(43) Pub. Date: Apr. 27, 2017

(54) AERATION SENSOR FOR A HYDRAULIC CIRCUIT

(71) Applicant: CATERPILLAR INC., Peoria, IL (US)

(72) Inventor: Hongliu DU, Naperville, IL (US)

(73) Assignee: CATERPILLAR INC., Peoria, IL (US)

(21) Appl. No.: 14/919,276

(22) Filed: Oct. 21, 2015

(51) Int. Cl. G01N 27/20; G01N 27/07

(52) U.S. Cl. CPC G01N 27/20; G01N 27/07; F04D 29/18

(57) ABSTRACT

A sensor is disclosed for detecting aeration of a fluid passing through a conduit. The sensor may have a first electrode with a first end mountable in a wall of the conduit, and a second end configured to be exposed to the fluid passing through the conduit. The sensor may also have a second electrode with a first end mountable in the wall of the conduit adjacent the first electrode, and a second end configured to be exposed to the fluid passing through the conduit. The sensor may further have a dielectric insulator disposed between the first ends of the first and second electrodes.

### TECHNICAL FIELD

The present disclosure relates generally to an aeration sensor and, more particularly, to an aeration sensor for a hydraulic circuit.

### BACKGROUND

Hydraulic machines such as dozers, loaders, excavators, backhoes, motor graders, and other types of heavy equipment use one or more hydraulic actuators to accomplish a variety of tasks. These actuators are fluidly connected to a pump of the machine that provides pressurized fluid to chambers within the actuators, and also connected to a sump of the machine that receives low-pressure fluid discharged from the chambers of the actuators. As the fluid moves through the chambers, the pressure of the fluid acts on hydraulic surfaces of the chambers to affect movement of the actuators. A flow rate of fluid through the actuators corresponds to a velocity of the actuators, while a pressure differential across the actuators corresponds to a force of the actuators.

An efficiency of a hydraulic machine can be directly affected by an efficiency of the associated hydraulic circuit. And one source of low-efficiency within the hydraulic circuit can be the pump. In particular, a hydraulic pump loses efficiency when gas is entrained in the hydraulic fluid, as the energy imparted to drive the pump is wasted compressing the gas instead of moving the hydraulic fluid.

The gas entrained in the hydraulic fluid passing through a pump can also be damaging to the pump. In particular, bubbles of the gas can collapse or implode when exposed to high-pressures, resulting in high-pressure jets of fluid shooting outward from the location of the bubble collapse. The high-pressure jets of fluid impinge against impeller blades of the pump, causing micro-abrasions within the blades. Over time, these micro-abrasions can cause the pump to wear prematurely and/or fail. In addition, the compression and implosion of the bubbles can cause the surrounding fluid to heat up. This additional heat must be dissipated from the hydraulic circuit in order to maintain a desired integrity of the fluid.

Gas can be introduced into the fluid of a hydraulic circuit in many ways. For example, the gas can exist in the fluid before the hydraulic circuit is filled with the fluid. In another example, the sump, a housing of the pump, and/or a conduit connecting the sump to the pump can rupture, allowing the gas to enter the normally closed circuit. Unfortunately, it can be difficult to determine when the gas enters the system or how much gas is in the system.

One attempt to address the issues discussed above is disclosed in U.S. Pat. No. 7,086,280 (the '280 patent) by Wakeman et al. that issued on Aug. 8, 2006. In particular, the '280 patent discloses an aeration sensing device. The aeration sensing device has a pair of spaced-apart concentric rings forming a first capacitor, through which a lubricant flows, and a second capacitor filled with non-aerated lubricant. The first and second capacitors are connected between first and second terminals, and first and fourth terminals, respectively, within a balanced bridge circuit. A signal generator is connected to opposing first and third terminals of the bridge circuit and generates an input signal, while a demodulator is connected to opposing second and forth terminals. A first resistor is connected between the first and second terminals, and a second resistor of equal value is connected between the third and fourth terminals. An impedance imbalance in the bridge circuit is generated when air becomes trapped in the lubricant flowing through the first capacitor, and the demodulator is configured to generate an output signal corresponding to the imbalance and to the aeration of the fluid.

Although the aeration sensing device of the '280 patent may be capable of detecting aeration of a fluid flowing through the device, it may still be less than optimal. In particular, the geometry of the device may consume a significant amount of space. In addition, it may not be possible to ensure that the non-aerated lubricant is always void of gas. If any gas is in the non-aerated lubricant, the signal generated by the demodulator may lack accuracy and consistency.

The disclosed aeration sensor and hydraulic circuit are directed to overcoming one or more of the problems set forth above and/or other problems of the prior art.

### SUMMARY

One aspect of the present disclosure is directed to a sensor for detecting aeration of a fluid passing through a conduit. The sensor may include a first electrode with a first end mountable in a wall of the conduit, and a second end configured to be exposed to the fluid passing through the conduit. The sensor may also include a second electrode with a first end mountable in the wall of the conduit adjacent the first electrode, and a second end configured to be exposed to the fluid passing through the conduit. The sensor may further include a dielectric insulator disposed between the first ends of the first and second electrodes.

Another aspect of the present disclosure is directed to a method of sensing aeration in a fluid. The method may include inserting tip ends of spaced-apart first and second electrodes through a conduit containing the fluid, such that the tip ends are exposed to the fluid. The method may also include exciting a first terminal connected to a base end of the first electrode protruding from the conduit, and detecting an impedance at a second terminal connected to a base end of the second electrode protruding from the conduit. The method may further include correlating the impedance to the aeration of the fluid.

Another aspect of the present disclosure is directed to a hydraulic circuit. The hydraulic circuit may include a sump, an actuator, and a pump having an inlet and an outlet. The hydraulic circuit may also include a first conduit connecting the pump to the sump, and a second actuator connecting the pump to the actuator. The hydraulic circuit may further include a sensor mounted to the first conduit at the inlet of the pump and having a primary axis oriented generally orthogonal to a flow of fluid through the first conduit. The sensor may be configured to generate a signal indicative of aeration of the fluid.

### BRIEF DESCRIPTION OF THE DRAWINGS

FIG. 1 is a diagrammatic illustration of an exemplary disclosed hydraulic circuit;

FIG. 2 is a diagrammatic illustration of an exemplary disclosed aeration sensor that may be used in conjunction with the hydraulic circuit of FIG. 1;

FIG. 3 is a schematic representation of the aeration sensor of FIG. 2; and

FIG. 4 is a flowchart depicting an exemplary operation of the hydraulic circuit of FIG. 1 using the aeration sensor of FIGS. 2 and 3.

### DETAILED DESCRIPTION

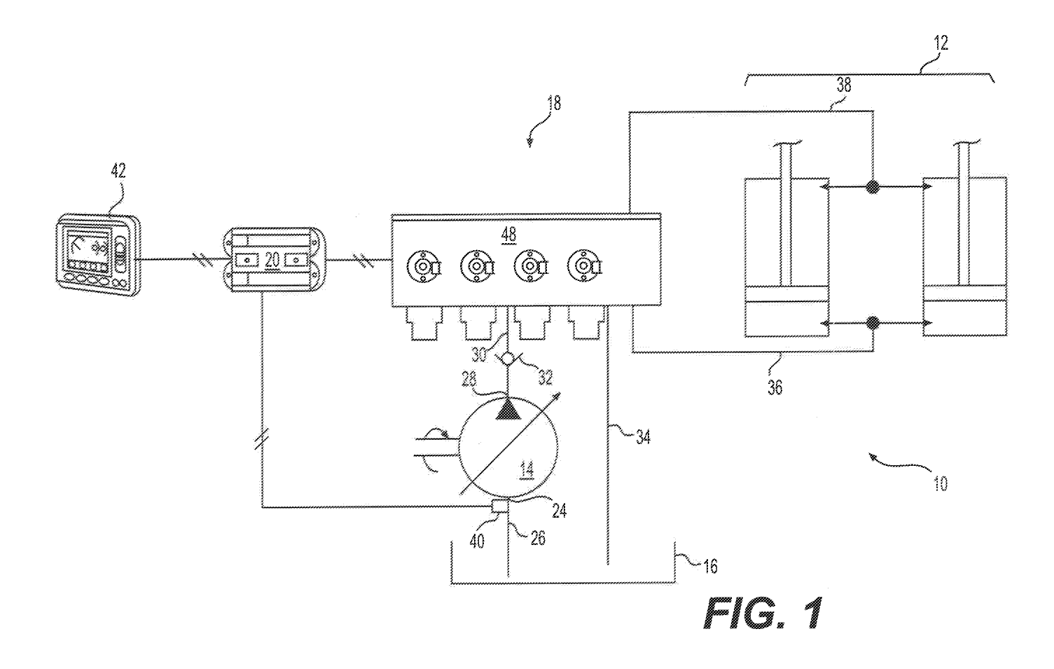

FIG. 1 illustrates an exemplary hydraulic circuit 10 having at least one actuator 12 that is movable when connected to a pressure differential. In the disclosed embodiment, two actuators 12 are shown that are arranged to operate in tandem. These actuators 12 are linear actuators (e.g., cylinders) that are commonly used to raise and lower the boom of a construction machine (e.g., an excavator—not shown). It is contemplated, however, that any number of actuators 12 could be included in hydraulic circuit 10, and that actuators 12 could embody linear or rotary actuators, as desired. Hydraulic circuit 10 may further include a pump 14 configured to draw low-pressure fluid from a sump 16, to pressurize the fluid, and to direct the pressurized fluid through a valve 18 to actuators 12. Valve 18 may be selectively energized by a controller 20 to regulate a flow direction, a flow rate, and/or a pressure of fluid communicated with actuators 12.

Pump 14 may have an inlet 24 fluidly connected to sump 16 by way of a suction conduit 26, and an outlet 28 connected to valve 18 via a pressure conduit 30. In some embodiments, a check valve 32 may be disposed in pressure conduit 30 to help ensure a unidirectional flow of fluid from pump 14 to valve 18. Pump 14 may be any type of pump known in the art, for example a fixed or variable displacement piston pump, gear pump, or centrifugal pump. Pump 14 may be driven by an engine, by an electric motor, or by another suitable power source.

Sump 16 may be connected to valve 18 via a drain conduit 34. Sump 16 may constitute a reservoir configured to hold the low-pressure supply of fluid. The fluid may include, for example, a dedicated hydraulic oil, an engine lubrication oil, a transmission lubrication oil, or any other fluid known in the art. One or more hydraulic circuits may draw fluid from and return fluid to sump 16. It is contemplated that hydraulic circuit 10 could be connected to multiple separate sumps 16 or to a single sump 16, as desired. A relief valve (not shown) could be associated with drain conduit 34 to help maintain a desired pressure within hydraulic circuit 10.

Valve 18 may fluidly communicate with actuators 12 via first and second control conduits 36, 38. As is known in the art, selective pressurization of control conduits 36, 38 may cause desired actuator movements.

Controller 20 may embody a single or multiple microprocessors that include a means for monitoring a hydraulic circuit operation and responsively energizing valve 18 to affect movement of actuator 12. For example, controller 20 may include a memory, a secondary storage device, a clock, and a processor, such as a central processing unit or any other means for accomplishing a task consistent with the present disclosure. Numerous commercially available microprocessors can be configured to perform the functions of controller 20. It should be appreciated that controller 20 could readily embody a general controller capable of controlling numerous other related functions. Various other known circuits may be associated with controller 20, including signal-conditioning circuitry, communication circuitry, and other appropriate circuitry. Controller 20 may be further communicatively coupled with an external computer system, instead of or in addition to including a computer system, as desired.

In some embodiments, controller 20 may rely on sensory information when regulating operation of hydraulic circuit 10. For example, controller 20 may communicate with one or more sensors 40 to detect parameters of hydraulic circuit 10, and then affect operation of hydraulic circuit 10 based on signals generated by sensor(s) 40. In the disclosed embodiment, a single aeration sensor 40 is included and mounted at inlet 24 of pump 14 (e.g., within a wall of suction conduit 26 or a housing of pump 14). As will be explained in more detail below, sensor 40 may be configured to generate signals indicative of an amount of aeration within the fluid passing into a low-pressure side of pump 14. Controller 20 may selectively affect operation of hydraulic circuit 10 based on the level of aeration in the fluid, as indicated via signals from sensor 40.

In the disclosed embodiment, controller 20 may additionally generate a warning based on values of the signals from sensor 40. For example, when a signal value exceeds a threshold aeration value, controller 20 may cause a visual warning to be shown on a display 42 associated with hydraulic circuit 10. The warning may include, for instance, an instruction to repair a suspected air leak in some component of hydraulic circuit 10 (e.g., within pump 14, suction conduit 26, and/or sump 16). The warning could also include instructions to shut down and/or to stop using hydraulic circuit 10. In some instances, the warning could additionally include audible tones and/or audible instructions, if desired.

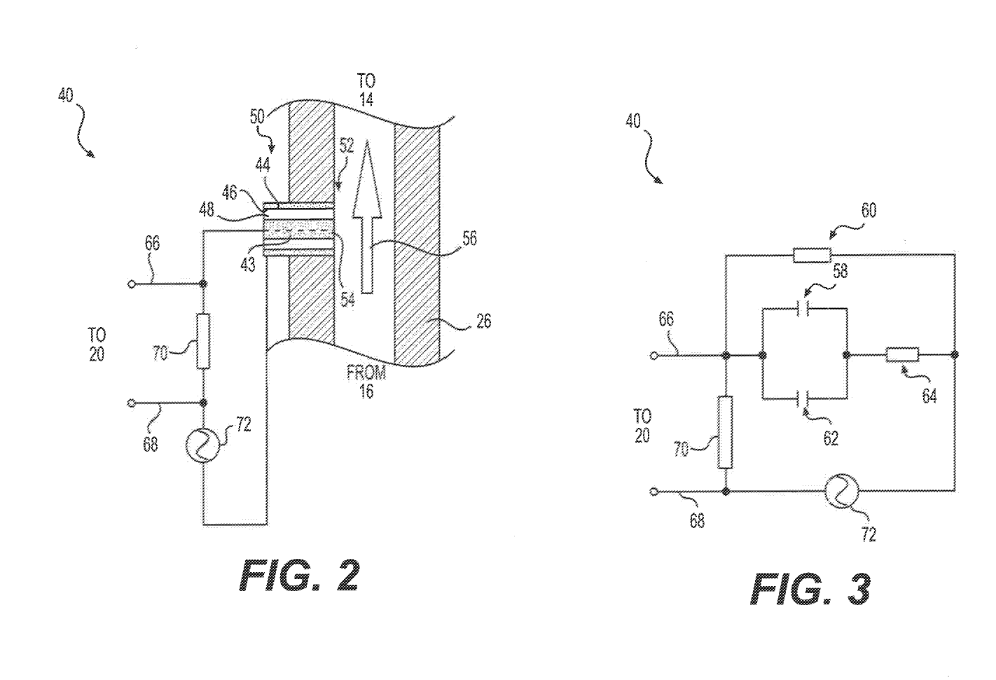

FIGS. 2 and 3 diagrammatically and schematically represent an exemplary disclosed embodiment of aeration sensor 40, respectively. As shown in FIG. 2, aeration sensor 40 may include first and second electrodes 43, 44 located adjacent each other. In the disclosed embodiment, first electrode 43 is generally cylindrical, while second electrode 44 is generally tubular and concentrically arranged to annularly encompass first electrode 43. An annular space 46 may be maintained between first and second electrodes 44, and filled with a dielectric insulator 48. Both of first and second electrodes 43, 44 may be fabricated from a conductive material and have base ends 50 and opposing tip ends 52.

Aeration sensor 40 may be mounted within a wall of suction conduit 26 and/or within a housing of pump 14, such that base ends 50 are located externally in isolation from the hydraulic fluid passing into pump 14, and tip ends 52 are located internally in communication with the hydraulic fluid. In the disclosed example, a primary axis 54 of aeration sensor 40 is oriented generally orthogonal to a flow direction (represented by an arrow 56) of the fluid, although other configurations may also be possible. In the disclosed configuration, base ends 50, together with dielectric insulator 48 therebetween, may comprise a first capacitor 58 and a first resistor 60 (shown schematically in FIG. 3). Likewise, tip ends 52, together with the fluid passing therebetween, may comprise a second capacitor 62 and a second resistor 64. First capacitor 58 and first resistor 60 may be arranged in parallel with second capacitor 62 and second resistor 64.

As also shown in FIG. 2, aeration sensor 40 may further include a first terminal 66 connected to first electrode 43, and a second terminal 68 connected to second electrode 44. A load resistor 70 may be connected between first and second terminals 66, 68. In some embodiments, load resistor 70 may be an adjustable type of resistor, such that signals generated by aeration sensor 40 may likewise be adjustable. An exciter (e.g., a sinusoidal type of power source) 72 may be connected to second terminal 68.

As will be described in more detail below, controller 20 may connect with first and second terminals 66, 68 to detect an overall impedance of aeration sensor 40. That is, the overall impedance of aeration sensor 40 may be variable and due, at least in part, to an amount of gas entrained in the fluid passing between tip ends 52 of aeration sensor 40. Specifically, the overall impedance of aeration sensor 40 may be a combination of the impedance between base ends 50 (i.e., through dielectric insulator 48) and the impedance between tip ends 52 (i.e., through the fluid). The impedance between base ends 50 may be generally constant, as the dielectric constant of dielectric insulator 48 between base ends 50 should not change under normal conditions. However, the impedance between tip ends 52 should be changing constantly, as the dielectric constant of the fluid passing between tip ends 52 changes with the amount of gas entrained in the fluid. Accordingly, an overall impedance of aeration sensor 40 will also constantly be changing (due to the changing impedance at tip ends 52) and will correspond to the aeration in the fluid entering pump 14. Controller 20 may be configured to correlate a value of this overall impedance to the aeration of the hydraulic fluid passing by tip ends 52 of aeration sensor 40. In some instances, controller 20 may use a formula to calculate the aeration of the fluid based on the overall impedance value. In other instances, controller 20 may reference the overall impedance value with a lookup table to determine the aeration of the fluid. Other methods for determining the aeration of the fluid based on the overall impedance value may also be possible.

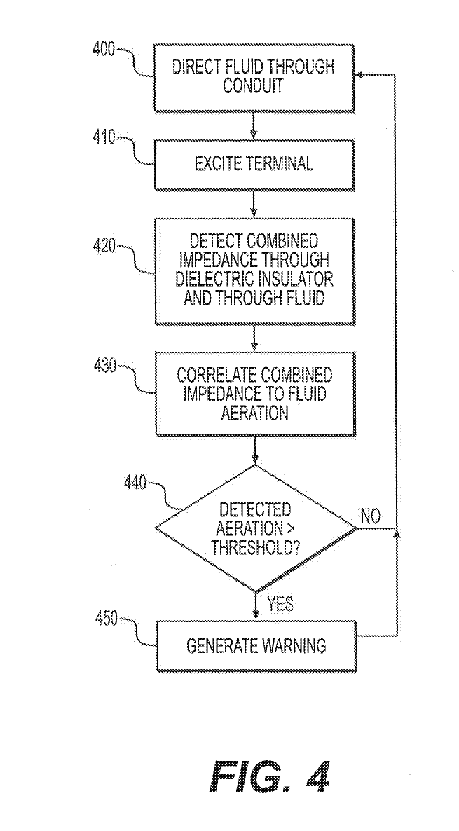

FIG. 4 is a flowchart depicting an exemplary operation of hydraulic circuit 10 using aeration sensor 40. FIG. 4 will be discussed in more detail in the following section to further clarify the disclosed concepts.

### INDUSTRIAL APPLICABILITY

The disclosed sensor may be applicable to any hydraulic circuit where knowledge of a fluid aeration level is important. The disclosed sensor may provide an indication of the aeration of the fluid, allowing adjustments/modifications/repairs to be completed in a timely manner before failure of the hydraulic circuit occurs. Operation of hydraulic circuit 10 will now be described with respect to FIG. 4.

During operation of hydraulic circuit 10 (referring to FIG. 1), pump 14 may be driven to draw in fluid from sump 16 via suction conduit 26 and to pressurize the fluid. The pressurized fluid may be directed past check valve 32 to valve 18 via pressure conduit 30 (Step 400). Controller 20 may then generate electronic signals that energize or de-energize particular portions of valve 18, allowing the pressurized fluid to pass through tool actuators 12 via first and/or second control conduits 36, 38. This fluid may create pressure imbalances within tool actuators 12 that result in a desired motion of tool actuators 12.

During normal operation of hydraulic circuit 10 (i.e., when no leaks are present in sump 16, suction conduit 26, or inlet 24 of pump 14), only fluid should be drawn into pump 14 and pump 14 may operate at a relatively high level of efficiency. However, during abnormal operation, it may be possible for gas (e.g., air) to be entrained in the fluid entering pump 14. As described above, the entrained air may reduce an efficiency of pump 14 and cause damage to pump 14 over time.

Accordingly, it can be important to monitor the aeration of the fluid within hydraulic circuit 10, such that action can be taken to improve pump efficiency or avoid potential damage.

Controller 20 may excite second terminal 68 during operation of hydraulic circuit 10 (Step 420), and monitor a resulting impedance at first terminal 66 (Step 430). It should be noted that the impedance monitored at first terminal 66 may be a combined impedance of the first and second sets of capacitors and resistors. That is, the impedance signal generated by aeration sensor 40 may be indicative of the impedance to the signal excited at second terminal 68 passing through dielectric insulator 48 at the base ends of first and second electrodes 43, 44 and through the fluid within suction conduit 26 at the tip ends of first and second electrodes 43, 44. Controller 20 may then reference the combined impedance with a table stored in memory to determine the correlated aeration of the fluid (Step 430). The table may be calibrated based on lab testing of the fluid under different known levels of aeration.

Controller 20 may then compare the corresponding aeration level to a threshold level (Step 440). The threshold level may be a level high enough to indicate a strong likelihood of structural damage to hydraulic system 10 that is allowing too much air to enter and mix with the fluid. In some embodiments, the threshold value may be a fixed value. In other embodiments, however, the threshold value may be a change in the correlated aeration value over time. For example, controller may determine the threshold value to be 10% greater than an aeration value first detected when hydraulic circuit 10 was first constructed or last serviced.

When the correlated aeration level exceeds the threshold value. controller 20 may selectively show a corresponding warning on display 42 (Step 450). Control may return from step 450 to step 400. Control may also return directly from step 440 to step 400, when the correlated aeration level is less than the threshold value. Control may continue to loop through steps 400-450 during operation of hydraulic system 10.

The disclosed sensor may be compact, inexpensive, and highly consistent. In particular, because of the geometry of aeration sensor 40, the way that aeration sensor 40 interacts with the fluid, and because of the orientation of aeration sensor 40 relative to fluid flow, the size of aeration sensor 40 may be small. The small size of aeration sensor 40 may lend itself to being relatively inexpensive. And because aeration sensor 40 may not need to rely on the dielectric constant of an assumed non-aerated fluid, a consistency in the output of aeration sensor 40 may be highly consistent.

It will be apparent to those skilled in the art that various modifications and variations can be made to the disclosed aeration sensor and hydraulic circuit. Other embodiments will be apparent to those skilled in the art from consideration of the specification and practice of the disclosed aeration sensor and hydraulic circuit. It is intended that the specification and examples be considered as exemplary only, with a true scope being indicated by the following claims and their equivalents.

What is claimed is:

1. A sensor for detecting aeration of a fluid passing through a conduit, comprising:
a first electrode having a first end mountable in a wall of the conduit, and a second end configured to be exposed to the fluid passing through the conduit;
a second electrode having a first end mountable in the wall of the conduit adjacent the first electrode, and a second end configured to be exposed to the fluid passing through the conduit; and
a dielectric insulator disposed between the first ends of the first and second electrodes.

2. The sensor of claim 1, wherein:
the first ends of the first and second electrodes, together with the dielectric insulator, form a first capacitor; and
the second ends of the first and second electrodes, together with the fluid, form a second capacitor connected in parallel with the first capacitor.

3. The sensor of claim 2, wherein:
the first ends of the first and second electrodes, together with the dielectric insulator, form a first resistor; and
the second ends of the first and second electrodes, together with the fluid, form a second resistor connected in parallel with the first capacitor.

4. The sensor of claim 3, further including:
a first terminal connected to the first electrode; and
a second terminal connected to the second electrode.

5. The sensor of claim 4, further including a load resistor connected between the first and second terminals.

6. The sensor of claim 5, wherein the load resistor is adjustable.

7. The sensor of claim 5, further including a sinusoidal exciter connected to one of the first and second terminals.

8. The sensor of claim 1, wherein:
the first electrode is a cylinder of conductive material; and
the second electric is a tube of conductive material positioned around the cylinder of conductive material.

9. A method of sensing aeration in a fluid, comprising:
providing fluid in a conduit, wherein tip ends of spaced-apart first and second electrodes are coupled through the conduit, and the tip ends are exposed to the fluid;
exciting a first terminal connected to a base end of the first electrode protruding from the conduit;
detecting an impedance at a second terminal connected to a base end of the second electrode protruding from the conduit; and
correlating the impedance to the aeration of the fluid.

10. The method of claim 9, wherein:
the first electrode is a cylinder of conductive material; and
the second electric is a tube of conductive material positioned around the cylinder of conductive material.

11. The method of claim 10, wherein the base ends of the cylinder and the tube are separated by a dielectric insulator.

12. The method of claim 9, wherein correlating the impedance to the aeration of the fluid includes referencing the impedance with a lookup table stored in memory.

13. The method of claim 9, further including selectively generating an alert when the aeration of the fluid exceeds a threshold value.

14. A hydraulic circuit, comprising:
a sump;
an actuator;
a pump having an inlet and an outlet;
a first conduit connecting the pump to the sump;
a second actuator connecting the pump to the actuator; and
a sensor mounted to the first conduit at the inlet of the pump and having a primary axis oriented generally orthogonal to a flow of fluid through the first conduit, the sensor being configured to generate a signal indicative of aeration of the fluid.

15. The hydraulic circuit of claim 14, further including:
a display; and
a controller in communication with the sensor and the display, the controller being configured to selectively generate a warning shown on the display when the signal indicates the aeration of the fluid exceeds a threshold aeration.

16. The hydraulic circuit of claim 14, wherein the sensor includes:
a first electrode having a first end mountable in a wall of the first conduit, and a second end configured to be exposed to the fluid passing through the conduit;
a second electrode having a first end mountable in the wall of the first conduit adjacent the first electrode, and a second end configured to be exposed to the fluid passing through the conduit; and
a dielectric insulator disposed between the first ends of the first and second electrodes.

17. The hydraulic circuit of claim 16, wherein:
the first ends of the first and second electrodes, together with the dielectric insulator, form a first capacitor and a first resistor; and
the second ends of the first and second electrodes, together with the fluid, form a second capacitor and a second resistor connected in parallel with the first capacitor.

18. The hydraulic circuit of claim 17, further including:
a sinusoidal exciter;
a first terminal connecting sinusoidal exciter to the first electrode;
a second terminal connecting the controller to the second electrode; and
a load resistor connected between the first and second terminals.

19. The hydraulic circuit of claim 18, wherein the load resistor is adjustable.

20. The hydraulic circuit of claim 18, wherein:
the first electrode is a cylinder of conductive material; and
the second electric is a tube of conductive material positioned around the cylinder of conductive material.
